(19) United States
(12) Patent Application Publication
(10) Pub. No.: US 2025/0050205 A1
(43) Pub. Date: Feb. 13, 2025

(54) CLOUD GAMING WIRELESS NETWORK OPTIMIZATION METHOD, APPARATUS AND DEVICE, AND STORAGE MEDIUM

(71) Applicant: SHENZHEN TCL NEW TECHNOLOGY CO., LTD., Shenzhen, Guangdong (CN)

(72) Inventor: Zhongwen XU, Shenzhen, Guangdong (CN)

(73) Assignee: SHENZHEN TCL NEW TECHNOLOGY CO., LTD., Shenzhen, Guangdong (CN)

(21) Appl. No.: 18/711,462

(22) PCT Filed: Oct. 13, 2022
(86) PCT No.: PCT/CN2022/125063

§ 371 Date: May 17, 2024

(30) Foreign Application Priority Data
Nov. 17, 2021 (CN) 202111364474.0

(51) Int. Cl. A63F 13/358; A63F 13/335

(52) U.S. Cl. CPC A63F 13/358; A63F 13/335

(57) ABSTRACT

The present disclosure provides a cloud gaming wireless network optimization method, apparatus and device, and a computer readable storage medium. The method of the present disclosure comprises: obtaining network detection data of a cloud gaming wireless network environment, and/or a cloud gaming running parameter of cloud gaming; determining a network evaluation result of the cloud gaming wireless network environment according to the network detection data and/or the cloud gaming running parameter; and determining a corresponding network optimization policy according to the network evaluation result, and optimizing the cloud gaming wireless network environment according to the network optimization policy. The cloud gaming wireless network optimization method can effectively improve the wireless anti-interference capability, reduce congestion, ensure network quality, and improve cloud gaming running experience while ensuring a bandwidth for cloud gaming.

This application claims the priority of Chinese Patent Application No. 202111364474.0, entitled “CLOUD GAMING WIRELESS NETWORK OPTIMIZATION METHOD, APPARATUS AND DEVICE, AND STORAGE MEDIUM”, filed on Nov. 17, 2021, the disclosure of which is incorporated herein by reference in its entirety.

### FIELD OF THE DISCLOSURE

The present disclosure relates to an Internet technology, and more particularly, to a cloud game wireless network optimization method, a device, an apparatus and a storage medium.

### BACKGROUND

Nowadays, with the rapid development of the computer and Internet field, the operation mode of video games is also constantly changing, from the initial arcade games to computer games, and then to mobile games that can be run on mobile terminals, such as mobile phones. With the development of cloud computing technology, cloud games relying on cloud computing are also derived. That is, games are run in the cloud, and the real-time pictures after game content calculation and rendering are transmitted to the user through cloud technology, which solves the hardware requirements for running large-scale games to a certain extent.

However, the game experience of cloud games is related to network quality, and a good cloud game service experience requires stable network support.

Conventionally, the wireless network connection of the cloud game is usually WIFI network connection. Due to the overlap of channels and the popularity of routers, the interference of each frequency band of the WIFI network in the operation process is serious, which greatly affects the cloud game experience in the wireless network connection mode. Therefore, the conventional cloud game wireless network needs to be optimized.

### SUMMARY

### Technical Problem

One objective of an embodiment of the present disclosure is to provide a method, a device, an apparatus, and a storage medium for optimizing a wireless network for a cloud game, to solve the above-mentioned technical issue of serious interferences of the cloud game wireless network.

### Solution to Technical Problem

### Technical Solution

In a first aspect, according to an embodiment of the present disclosure, a method for optimizing a wireless network for a cloud game. The method comprises:
obtaining network detection data of a wireless network environment of the cloud game and/or a cloud game operation parameter of the cloud game;
determining a network assessment result of the wireless network environment according to the network detection data and/or the cloud game operation parameter; and
determining a corresponding network optimization strategy according to the network evaluation result, and optimizing the wireless network environment according to the network optimization strategy.

In some embodiments of the present disclosure, the step for determining the network assessment result of the wireless network environment according to the network detection data and/or the cloud game operation parameters comprises:
calculating a network detection score corresponding to each of the network detection data;
calculating a network environment score of the wireless network environment according to the network detection score; and/or
determining the cloud game operation state according to the cloud game operation parameter;
determining the corresponding network assessment result based on the network environment score and/or the cloud game operation status.

In some embodiments of the present disclosure, the step for calculating network detection score corresponding to each of the network detection data comprises:
querying a preset network parameter weight database to obtain a network score weight corresponding to the network detection data;
according to the network scoring weight, performing a weighted calculation on the network detection data to obtain the network detection score.

In some embodiments of the present disclosure, the step of determining the corresponding network optimization strategy according to the network evaluation result and optimizing the wireless network environment according to the network optimization strategy comprises:
upon a condition that the network assessment result corresponding to the wireless network environment is a strong interference network and/or the wireless network environment is stuck, determining the network optimization strategy corresponding to the wireless network environment to be a first network optimization strategy;
optimizing the wireless network environment according to the first network optimization strategy, wherein the first network optimization strategy is to reduce a wireless aggregation rate, reduce a wireless transmission rate, and switch a wireless negotiated bandwidth.

In some embodiments of the present disclosure, the step of determining the corresponding network optimization strategy according to the network evaluation result and optimizing the wireless network environment according to the network optimization strategy comprises:
upon a condition that the network evaluation result corresponding to the wireless network environment is a weak interference network and/or the wireless network environment is good, determining the network optimization strategy corresponding to the wireless network environment to be a second network optimization strategy;
optimizing the cloud game wireless network environment according to the second network optimization strategy, where the second network optimization strategy is to increase a wireless aggregation rate, increase a wireless transmission rate, and increase a cloud game screen bit rate.

In some embodiments of the present disclosure, the step of determining the corresponding network optimization strategy according to the network evaluation result and optimizing the wireless network environment according to the network optimization strategy comprises:
obtaining an updated cloud game operation parameter, and determining an optimization status of the cloud game based on the updated cloud game operation parameter;
evaluating the wireless network environment according to the optimization state, and obtaining a network optimization evaluation result;
optimizing the wireless network environment for a second time according to the network optimization evaluation result.

In some embodiments of the present disclosure, the cloud game operation parameter comprises at least one of:
a cloud game network latency;
a proportion of cloud game lag;
a cloud game screen bit rate;
an average cloud game rate.

According to an embodiment of the present disclosure, a cloud game wireless network optimization device is disclosed. The device comprises:
a network detection module, configured to obtain network detection data of a wireless network environment of the cloud game and/or a cloud game operation parameter of the cloud game;
a network identification module, configured to determine a network assessment result of the wireless network environment according to the network detection data and/or the cloud game operation parameter; and
a network optimization module, configured to a corresponding network optimization strategy according to the network evaluation result, and dynamically optimize the wireless network environment according to the network optimization strategy.

According to an embodiment of the present disclosure, a cloud game wireless network optimization device is disclosed. The cloud game wireless network optimization device comprises:
one or more processors;
a memory;
one or more applications, stored in the memory and configured to be executed by the processor to perform the method for optimizing a wireless network for a cloud game.

According to an embodiment of the present disclosure, a computer readable medium is disclosed. The computer readable medium stores computer program. The computer program is executed by a processor to perform the method for optimizing a wireless network for a cloud game.

### Advantageous Effect of the Present Disclosure

### Advantageous Effect

The technical scheme according to an embodiment of the present disclosure includes: obtaining network detection data of a wireless network environment of the cloud game and/or a cloud game operation parameter of the cloud game; determining a network assessment result of the wireless network environment according to the network detection data and/or the cloud game operation parameter; and determining a corresponding network optimization strategy according to the network evaluation result, and optimizing the wireless network environment according to the network optimization strategy. The technical scheme according to an embodiment of the present disclosure determines the network evaluation result by evaluating the network detection data in the wireless network environment of the cloud game and the cloud game operation parameter of the cloud game, determines the network situation of the wireless network environment according to the network evaluation result, and selects the corresponding network optimization strategy to optimize the wireless network environment based on the network evaluation result. In this way, the wireless anti-interference ability could be increased, the congestion is reduced, the network quality could be ensured, and the running experience of the cloud game can be effectively improved under the premise of ensuring the bandwidth of the cloud game.

### BRIEF DESCRIPTION OF THE DRAWINGS

### Introduction of the Drawings

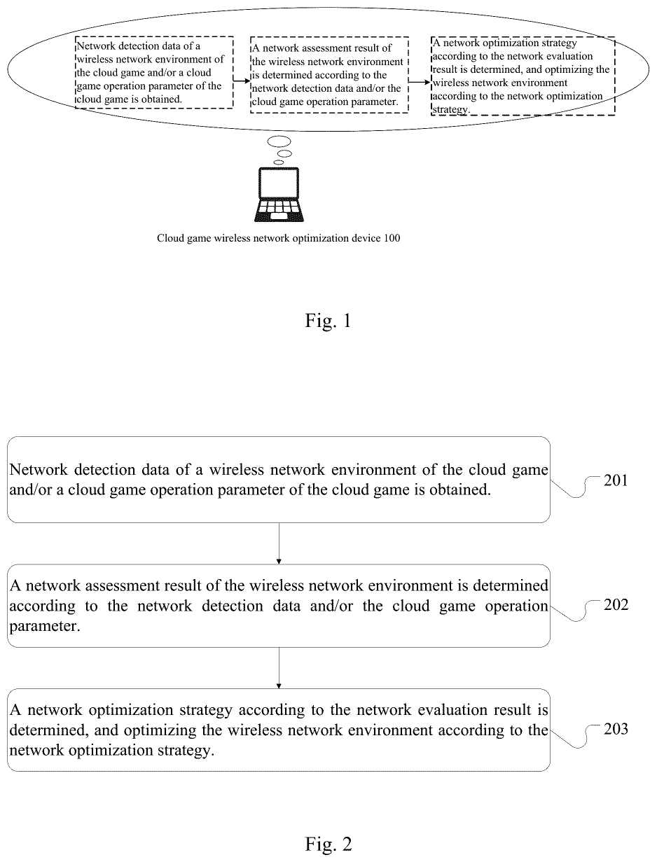

FIG. 1 is a diagram of a scene of a cloud game wireless network optimization method according to an embodiment of the present disclosure.

FIG. 2 is a flow chart of a cloud game wireless network optimization method according to an embodiment of the present disclosure.

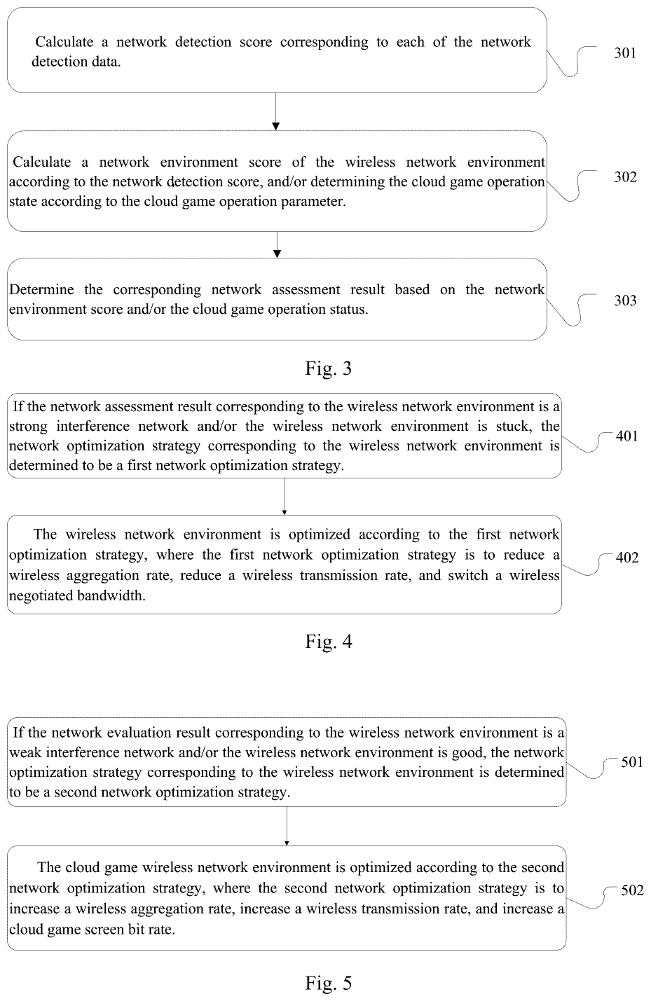

FIG. 3 is a flow chart of a cloud game wireless network optimization method according to another embodiment of the present disclosure.

FIG. 4 is a flow chart of a network optimization strategy for a strongly interfering network and/or a network environment jam in the cloud game wireless network optimization method according to an embodiment of the present disclosure.

FIG. 5 is a flow chart of a network optimization strategy for a weak interference network and/or a good network environment in the cloud game wireless network optimization method according to an embodiment of the present disclosure.

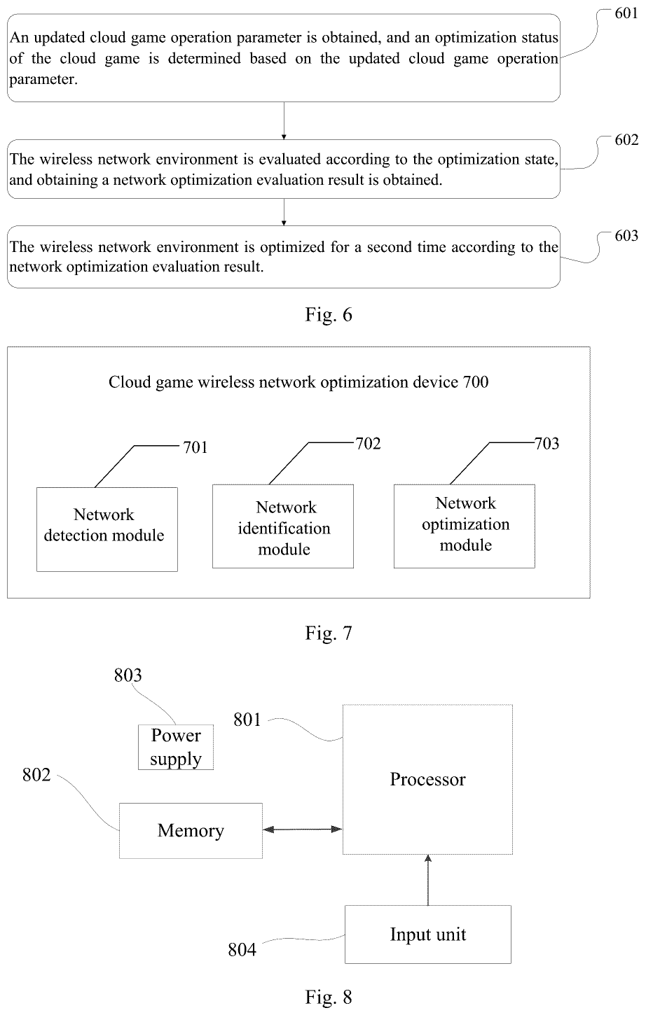

FIG. 6 is a flow chart of the flow of an embodiment of a cloud game wireless network optimization method performing an optimization for a second time according to the operation status of the cloud game.

FIG. 7 is a diagram of a cloud game wireless network optimization device according to an embodiment of the present disclosure.

FIG. 8 is a diagram a cloud game wireless network optimization apparatus according to an embodiment of the present disclosure.

### EMBODIMENTS OF THE PRESENT DISCLOSURE

### Detailed Description of the Present Disclosure

The technical solution in the embodiment of the present disclosure will be clearly and completely described below in conjunction with the accompanying drawings in the embodiments of the present disclosure, and it is obvious that the described embodiment is only a part of the embodiment of the present disclosure, not all of the embodiments. Based on the embodiments in the present disclosure, all other embodiments obtained by a person skilled in the art without making creative work belong to the scope of protection of the present disclosure.

The term “and/or” appearing in the present disclosure may be an association that describes the object of association, indicating that there can be three kinds of relationships, for example, A and/or B, which can denote the existence of A, the existence of both A and B, and the existence of B alone. In addition, the character “/” in this application generally indicates that the relationship between the preceding and following related objects is an “or”.

The terms “first”, “second”, etc., in the description and claims of the present disclosure and in the above-mentioned drawings are used to distinguish similar objects and are not necessarily used to describe a particular order or sequence. It should be understood that the data thus used are interchangeable where appropriate so that the embodiments described here can be implemented in an order other than what is illustrated or described here. In addition, the terms “including” and “having” and any variations thereof are intended to cover non-exclusive inclusions, e.g., a process, method, system, product or apparatus comprising a series of steps or modules need not be limited to those steps or modules that are clearly listed, but may include other steps or modules that are not clearly listed or are inherent to those processes, methods, products or equipment. The naming or numbering of the steps that appear in this application does not imply that they must be at the time indicated by the nomenclature or number. The steps in the method flow are executed in a logical sequence, and the process steps that have been named or numbered can be changed in order of execution according to the technical purpose to be achieved, as long as the same or similar technical effect can be achieved. The division of modules appearing in the present disclosure is a logical division, and there may be another division mode when it is realized in practical application, for example, a plurality of modules can be combined or integrated in another system, or some features can be ignored or not performed, in addition, the coupling or direct coupling or communication connection between each other shown or discussed may be through some interfaces, and the indirect coupling or communication connection between modules may be electrical or other similar forms, which are not limited in the present disclosure. In addition, the module or submodule described as a separate part may or may not be physically separated, may or may not be a physical module, or may be distributed into a plurality of circuit modules, and some or all of the modules can be selected to achieve the purpose of the present disclosure scheme according to actual needs.

In the present disclosure, the word “exemplary” is used to mean “to be used as an example, illustration or illustration”. Any embodiment described as “exemplary” in this application is not necessarily to be construed as being superior or advantageous over other embodiments. In order to enable any person skilled in the art to realize and use the present disclosure, the following description is given. In the following description, details are listed for the purpose of interpretation. It should be understood that a person of ordinary skill in the art can recognize that the present disclosure can be realized without the use of these specific details. In other examples, the well-known structure and process are not elaborated to avoid unnecessary details obscure the description of the invention. Therefore, the invention is not intended to be limited to the embodiments shown, but is consistent with the widest range of principles and features disclosed in the present disclosure.

Nowadays, with the rapid development of the computer and Internet field, the operation mode of video games is also constantly changing, from the initial arcade games to computer games, and then to mobile games that can be run on mobile terminals, such as mobile phones. With the development of cloud computing technology, cloud games relying on cloud computing are also derived. That is, games are run in the cloud, and the real-time pictures after game content calculation and rendering are transmitted to the user through cloud technology, which solves the hardware requirements for running large-scale games to a certain extent.

However, the game experience of cloud games is related to network quality, and a good cloud game service experience requires stable network support.

Conventionally, the wireless network connection of the cloud game is usually WIFI network connection. Due to the overlap of channels and the popularity of routers, the interference of each frequency band of the WIFI network in the operation process is serious, which greatly affects the cloud game experience in the wireless network connection mode. Therefore, the conventional cloud game wireless network needs to be optimized. According to an embodiment, a cloud game wireless network optimization method, a device, an apparatus and a computer-readable storage medium are disclosed.

The cloud game wireless network optimization method in an embodiment of the present disclosure is applied to a cloud game wireless network optimization device. The cloud game wireless network optimization device is arranged in the cloud game wireless network optimization apparatus. The cloud game wireless network optimization apparatus is provided with one or more processors, a memory, and one or more applications stored in the memory and configured to be executed by the processor to implement the cloud game wireless network optimization method. The cloud game wireless network optimization apparatus can be a smart terminal, such as a mobile phone, a tablet, a smart TV, a routing device, a network device, and a smart PC, Optionally, cloud game wireless network optimization apparatus can be a single server or a service cluster of multiple servers.

Please refer to FIG. 1. FIG. 1 is a diagram of a scene of a cloud game wireless network optimization method according to an embodiment of the present disclosure. In this embodiment, the scene comprises a cloud game wireless network optimization apparatus 100 (the cloud game wireless network optimization apparatus 100 is integrated with a cloud game wireless network optimization device), and a computer-readable storage medium corresponding to the cloud game wireless network optimization device 100 runs in the cloud game wireless network optimization apparatus 100, so as to perform the steps of cloud game wireless network optimization.

The cloud game wireless network optimization apparatus in the scene of the cloud game wireless network optimization method shown in FIG. 1 or the device contained in the cloud game wireless network optimization apparatus does not constitute a limitation of the present disclosure. That is, the number of devices and the type of apparatus contained in the scene of the cloud game wireless network optimization method or the number of devices and the type of devices contained in each apparatus do not affect the overall implementation of the technical solution according to an embodiment of the present disclosure. Those changes can be regarded as the equivalent replacement or derivation of the present disclosure and fall within the scope of the present disclosure.

The cloud game wireless network optimization apparatus 100 is configured for: obtaining network detection data of a wireless network environment of the cloud game and/or a cloud game operation parameter of the cloud game; determining a network assessment result of the wireless network environment according to the network detection data and/or the cloud game operation parameter; and determining a corresponding network optimization strategy according to the network evaluation result, and optimizing the wireless network environment according to the network optimization strategy.

The cloud game wireless network optimization apparatus 100 may be an independent network optimization apparatus or a network optimization cluster composed of network optimization devices, such as the cloud game wireless network optimization apparatus 100 described in an embodiment of the present disclosure, which includes, but is not limited to, a mobile phone, a smart TV, a computer, a network host and a cloud server.

Those skilled in the art can understand that the application environment shown in FIG. 1 is only one example of the application scene related to the present disclosure, and does not constitute a limitation of the scene of the present disclosure. Other application scene may include more or fewer cloud game wireless network optimization apparatuses or cloud game wireless network optimization network connection relationships than those shown in FIG. 1. For example, only one wireless network optimization apparatus is shown in FIG. 1, and it is understood that the scene of the cloud game wireless network optimization method may also include one or more other cloud game wireless network optimization apparatuses. This change also falls within the scope of the present disclosure.

The scene of the cloud game wireless network optimization method shown in FIG. 1 is only an example, and the scene of the cloud game wireless network optimization method described in this embodiment is to more clearly illustrate the technical scheme of this embodiment and does not constitute any limitation of the present disclosure.

Based on the above-mentioned scenarios of the cloud game wireless network optimization method, an example of the cloud game wireless network optimization method is proposed.

Please refer to FIG. 2. FIG. 2 is a flow chart of a cloud game wireless network optimization method according to an embodiment of the present disclosure. The method comprises following Steps 201-203:

Step 201: obtaining network detection data of a wireless network environment of the cloud game and/or a cloud game operation parameter of the cloud game.

The cloud game wireless network optimization method in this embodiment is applied to the cloud game wireless network optimization apparatus, and the types and quantities of cloud game wireless network optimization apparatuses are not limited. That is, the cloud game wireless network optimization apparatus may be a smart terminal or a server. In a specific embodiment, the cloud game wireless network optimization apparatus is a smart TV.

Specifically, when the cloud game wireless network optimization apparatus is in an operation state. The cloud game wireless network optimization apparatus receives a cloud game launch request, wherein the cloud game launch request is triggered by the user through the remote control, controller, touch screen, and gesture to request the cloud game wireless network optimization apparatus to start a certain cloud game. After receiving the cloud game launch request, the cloud game wireless network optimization apparatus locates the cloud game to which the cloud game launch request points to, starts the cloud game, and displays the cloud game start screen on the display interface of the cloud game wireless network optimization apparatus. Here, the cloud game is a game program that renders the game on the server side based on the cloud computing and transmits the compressed video data to the user terminal through the network after the rendering is completed.

Specifically, the cloud game wireless network optimization apparatus detects the current network mode after the cloud game is started. Optionally, the current network mode can include a wired network connection or a wireless network connection (WIFI connection), or other network connections. Specifically, when the cloud game wireless network optimization apparatus detects that the current networking mode is a wireless network connection, it performs environmental interference detection on the cloud game wireless network environment and obtains the network detection data of the wireless network environment of the cloud game.

Specifically, when the cloud game wireless network optimization apparatus recognizes that the networking mode is a wireless connection, it reads the network detection data of the wireless connection. Optionally, the network detection data includes one or more of the wireless accesses, the negotiated bandwidth, the wireless signal strength, the packet loss, and the wireless channel duty cycle.

Optionally, cloud game can obtain a cloud game operation parameter during cloud game operation without the need for the network optimization apparatus. Optionally, the cloud game running parameter include one or more of the cloud game network latency, the cloud game lag ratio, the cloud game screen bit rate, etc.

After obtaining the network detection data of the wireless network environment and/or the cloud game operation parameter of the cloud game, the cloud game wireless network optimization apparatus detects the wireless network environment based on the obtained network detection data and/or the cloud game running parameter to determine the network assessment result of the wireless network environment.

Step 202: determining a network assessment result of the wireless network environment according to the network detection data and/or the cloud game operation parameter.

In this embodiment, after establishing a wireless network connection, the cloud game wireless network optimization apparatus determines the hardware attributes of the wireless network device and the wireless network frequency band, and presets a network evaluation strategy according to the hardware attributes of the wireless network device and the wireless network frequency band. Here, the network evaluation strategy is an evaluation strategy that determines the network evaluation result of the current cloud game network by carrying out overall calculations according to the detection data and/or the cloud game operation parameter of each network.

Specifically, after obtaining one or more network detection data, which may include the number of wireless accesses, the negotiated bandwidth, the wireless signal strength, the packet loss rate and the wireless channel duty cycle, the cloud game wireless network optimization apparatus calculates the network detection score of the network detection data according to the preset network evaluation strategy, determines the network interference level according to the calculation result, and obtains the network evaluation information. Here, the network interference level is the evaluation interval that reflects the network interference degree of the network environment preset by the cloud game wireless network optimization apparatus. Optionally, in a specific embodiment, the cloud game wireless network optimization apparatus is preset to reflect the network interference level preset in the network evaluation strategy that reflects the cloud game wireless network environment, including a strong interference network and a weak interference network. Optionally, after obtaining the network evaluation result, the cloud game wireless network optimization apparatus generates the network evaluation information on the display interface, and the network evaluation information is used to reflect the network evaluation result of the wireless network environment.

Optionally, the cloud game wireless network optimization apparatus can also determine the network evaluation result of the wireless network environment during the cloud game operation process based on the cloud game operation parameter. Specifically, the cloud game wireless network optimization apparatus collects the cloud game operation parameter of the cloud game in real time during the cloud game operation and determines the cloud game operation status based on the cloud game running parameter. Optionally, during the operation of the cloud game, the network evaluation result includes the network lag and the network status (network is good or not).

Specifically, in an embodiment, after starting the cloud game, the cloud game wireless network optimization apparatus calculates the network detection score corresponding to the network detection data according to the network evaluation strategy and determines that the network interference level corresponding to the current wireless network environment is a strong interference network according to the calculation result. Thus, the cloud game wireless network optimization apparatus determines that the network environment where the current user is located is poor and there is strong network interference, and generates a network assessment result associated with the strong interference network, which indicates that the network is not conducive to the operation of the cloud game, and the user experience is poor. The cloud game wireless network optimization apparatus generates an assessment notification information on the display interface for a network with strong interference results.

In another embodiment, after starting the cloud game, the cloud game wireless network optimization apparatus calculates the network detection score corresponding to the network detection data according to the network evaluation strategy and determines that the network interference level corresponding to the current cloud game wireless network environment is a weak interference network according to the calculation result. Thus, the cloud game wireless network optimization apparatus determines that the cloud game wireless network environment where the current user is located is a good network environment and can run the cloud game smoothly, and generates a network assessment result associated with the weak interference network. Then, the cloud game wireless network optimization apparatus generates an assessment notification information that the network evaluation result is weak interference on the display interface.

Step 203: determining a corresponding network optimization strategy according to the network evaluation result, and optimizing the wireless network environment according to the network optimization strategy.

In this embodiment, the cloud game wireless network optimization apparatus presets a corresponding network optimization strategy for different network interference situations that may exist in the wireless network connection. After determining the network evaluation of the network environment according to the network evaluation results, the cloud game wireless network optimization apparatus selects the network optimization strategy corresponding to the network evaluation to optimize the wireless network environment.

Specifically, after obtaining the network evaluation situation, the cloud game wireless network optimization apparatus triggers the optimization notification information, which is the notification information that carries the network evaluation result, and asks the user whether to optimize the wireless network. Optionally, the notification message can be a pop-up message, a drop-down message, a bubble message, or in any other notification styles. The cloud game wireless network optimization apparatus receives the network optimization instruction sent by the user after sending the optimization notification information.

After receiving the network optimization instruction sent by the user, the cloud game wireless network optimization apparatus obtains the network optimization strategy corresponding to the network evaluation result, and adjusts the wireless network parameter in the cloud game wireless network environment according to the network optimization strategy. Optionally, the wireless network parameter adjusted by the cloud game wireless network optimization apparatus includes the wireless aggregation rate, the wireless transmission rate, and the wireless negotiated bandwidth.

After adjusting the wireless network parameters, the cloud game wireless network optimization apparatus disconnects the wireless network and reconnects to the wireless network within a preset time, so that the cloud game wireless network optimization apparatus and the wireless access point negotiate the new wireless network parameter, and a network acceleration success notification could be generated on the cloud game wireless network optimization apparatus.

Optionally, after the optimization is successful, the cloud game wireless network optimization apparatus runs the corresponding cloud game, detects the cloud game operation parameter of the wireless network environment in real time, determines the cloud game operation status, and performs the optimization of the wireless network environment for the second time based on the cloud game operation status.

In this embodiment, the cloud game wireless network optimization apparatus can obtain the network detection data of the wireless network environment and calculate the network detection score of the network detection data, thereby determining the network assessment result of wireless network environment. In addition, the cloud game wireless network optimization apparatus can determine the corresponding network optimization strategy according to the network evaluation result and perform the corresponding dynamic adjustment of the wireless network parameter, so as to optimize the wireless network environment. In this way, under the premise of ensuring the bandwidth of the cloud game, the wireless anti-interference ability can be effectively improved, the congestion can be reduced, the network quality can be ensured, and the operation experience of the cloud game can be improved.

Please refer to FIG. 3. FIG. 3 is a flow chart of a cloud game wireless network optimization method according to another embodiment of the present disclosure.

Based on the above embodiment, the cloud game wireless network optimization method further comprises Steps 301-303.

Step 301: calculating a network detection score corresponding to each of the network detection data.

Step 302: calculating a network environment score of the wireless network environment according to the network detection score, and/or determining the cloud game operation state according to the cloud game operation parameter.

Step 303: determining the corresponding network assessment result based on the network environment score and/or the cloud game operation status.

In this embodiment, the cloud game wireless network optimization apparatus correspondingly presets the network parameter weight database according to the obtained network detection data, and the network parameter weight database presets the network parameter weights corresponding to the network detection data according to the attributes of the network detection data. Here, each type of network detection data corresponds to a network parameter weight.

Specifically, the cloud game wireless network optimization apparatus collects network detection data according to the requirement for detecting the scene of the wireless network environment. Optionally, the collected network detection data includes one or more of the wireless access numbers, the negotiated bandwidth, the wireless signal strength, the packet loss rate, and the wireless channel duty cycle. After the network detection data is collected, the network detection score corresponding to the network detection data is calculated according to the specific parameter of the network detection data. Here the network detection score is an evaluation score that reflects the operation of a network detection data.

Specifically, the cloud game wireless network optimization apparatus obtains the number of wireless access (APs) of the wireless network environment, determines the number of wireless connections of the current channel, and calculates the network detection score of the wireless access number. Here, when the wireless access number is greater, the wireless network environment is worse and the network detection score is lower.

Specifically, the cloud game wireless network optimization apparatus obtains the negotiated bandwidth of the wireless network environment, obtains the throughput of the wireless network environment, and calculates the network detection score of the negotiated bandwidth when the throughput meets the network transmission requirements of the cloud game. Here, when the throughput meets the network transmission requirements, the negotiated bandwidth of the wireless network environment is smaller, the anti-interference capability is stronger and the network detection score is higher.

Specifically, the cloud game wireless network optimization apparatus obtains the wireless signal strength of the wireless network environment, determines the wireless signal situation of the wireless network environment, and calculates the network detection score corresponding to the wireless signal strength. Here, when the wireless signal strength is stronger, the corresponding network detection score is higher.

Specifically, the cloud game wireless network optimization apparatus obtains the packet loss rate of the wireless network environment, determines the network connection of the wireless network environment, and calculates the network detection score corresponding to the packet loss rate. Here, when the packet loss rate is higher, the corresponding network connection is worse, and the corresponding network detection score is lower.

Specifically, the cloud game wireless network optimization apparatus obtains the wireless channel duty cycle of the wireless network environment, and calculates the network detection score corresponding to the wireless channel duty cycle. Here, when the wireless channel duty cycle is higher, the wireless network environment is worse, and the corresponding network detection score is lower.

Specifically, after obtaining the detection data of each network, the cloud game wireless network optimization apparatus inputs the network detection data into the network parameter weight database and queries the network score weight corresponding to the network detection data. Here, each type of network detection data corresponds to a network score weight.

After obtaining the network score weight of each network detection data, the cloud game wireless network optimization apparatus calculates the weighted score of the network detection data according to the corresponding scoring standards of each network detection data, so as to obtain the weighted network detection score.

After obtaining the weighted network detection score corresponding to each network detection data, the cloud game wireless network optimization apparatus sums the weighted network detection scores corresponding to each network detection data to obtain the network environment score of the wireless network environment. Here, the network environment score is an evaluation score that reflects the situation of the wireless network environment.

Optionally, the interference level threshold and the corresponding interference level interval are preset in the cloud game wireless network optimization apparatus to distinguish network interference levels. After obtaining the network environment score of the wireless network environment, the cloud game wireless network optimization apparatus determines the interference level interval into which the network environment score falls and then determines the network evaluation result of the current network environment of the cloud game wireless network optimization apparatus according to the interference level interval into which the network environment score falls.

Optionally, in an embodiment, the cloud game wireless network optimization apparatus is preset to distinguish between the network interference level interval of the strong interference level and the network interference level threshold of the weak interference level. The range of the strong interference level interval is the scoring range between the network environment score of 0 and the strong interference level threshold, and the weak interference level interval is the scoring range between the strong interference level threshold and the weak interference level threshold, where the strong interference level threshold is smaller than the weak interference level threshold.

Specifically, the cloud game wireless network optimization apparatus calculates the network environment score of the current network environment and determines that the network environment score falls into the network interference level range. If the network environment score is within the threshold range of the strong interference level, the cloud game wireless network optimization apparatus determines that the network environment score falls into the strong interference level range. If the network environment score is within the strong interference level threshold to the weak interference level threshold, the cloud game wireless network optimization apparatus determines that the network environment score falls into the weak interference level range. If the network environment score is within the range greater than the weak interference level threshold, the cloud game wireless network optimization apparatus determines that the network environment score falls into the no interference level range. The cloud game wireless network optimization apparatus determines the network evaluation result of the network environment according to the interference level interval of the network environment score and perform a dynamic optimization according to the network optimization strategy corresponding to the network evaluation results.

Optionally, during the operation of the cloud game, the cloud game wireless network optimization apparatus can also determine the operation status of the cloud game based on the operation parameter of the cloud game and determine the network evaluation result based on the operation status of the cloud game.

Specifically, the cloud game wireless network optimization apparatus collects the cloud game operation parameter of the cloud game in real time during the operation of the cloud game, and determines the cloud game operation status based on the cloud game operation parameter. Optionally, the cloud game operation parameter includes the network latency of cloud game, the proportion of cloud game lag, and the cloud game screen bit rate. Here, the proportion of cloud game lag is the proportion of network lag of 100 ms and more than 200 ms during the operation of the cloud game.

Optionally, the cloud game wireless network optimization apparatus could determine the cloud game operation status according to the cloud game network latency, the proportion of cloud game lag, and the cloud game screen bit rate. Specifically, in the process of cloud game operation, if the network latency and the proportion of the cloud game lag are both higher than the preset thresholds, the network evaluation result of the cloud game is determined to be network lag. If the network latency and the proportion of the cloud game lag are both lower than the preset thresholds, the network evaluation result of the cloud game is determined to be good network.

In this embodiment, the cloud game wireless network optimization apparatus calculates the weighted network detection score corresponding to each network detection data and sums the network detection score of each network to obtain a network environment score reflecting the current wireless network environment; determines the network assessment result corresponding to the network environment score according to the interference level interval into which the network environment score falls; and/or determines the network evaluation result through the operation status of cloud games, so as to select the corresponding network optimization strategy to optimize the wireless network environment, realize dynamic optimization of the wireless network environment, and improve the smoothness of cloud game operation.

Please refer to FIG. 4. FIG. 4 is a flow chart of a network optimization strategy for a strongly interfering network and/or a network environment jam in the cloud game wireless network optimization method according to an embodiment of the present disclosure.

In the following disclosure, the optimization based on the network optimization strategy corresponding to a network evaluation result representing a strong interference network and/or a stuck network will be illustrated. The method comprises the following Steps 401-402.

Step 401: if the network assessment result corresponding to the wireless network environment is a strong interference network and/or the wireless network environment is stuck, determining the network optimization strategy corresponding to the wireless network environment to be a first network optimization strategy.

Step 402: optimizing the wireless network environment according to the first network optimization strategy, wherein the first network optimization strategy is to reduce a wireless aggregation rate, reduce a wireless transmission rate, and switch a wireless negotiated bandwidth.

In this embodiment, the cloud game wireless network optimization apparatus obtains a network environment score corresponding to the wireless network environment, determines that the network environment score is less than the preset strong interference level threshold, determines that the network environment score falls into the strong interference level range, determines that the network evaluation result corresponding to the wireless network environment is a strong interference network, and/or detects the operation status of the cloud game and determines that the network assessment result is network lag, and the cloud gaming wireless network optimization device determines that the network optimization strategy corresponding to the current wireless environment is the first network optimization strategy. Here, the first network optimization strategy is the network optimization strategy optimized for a strong interference network and/or a stuck network.

Specifically, after determining that the network optimization strategy corresponding to the wireless network environment is the first network optimization strategy, the cloud game wireless network optimization apparatus optimizes the wireless network environment according to the first network optimization strategy.

Specifically, the cloud game wireless network optimization apparatus adapts the wireless network parameter according to the first network optimization strategy, reduces the wireless aggregation rate, reduces the wireless transmission rate, and reduces the wireless negotiated bandwidth under the premise of ensuring that the throughput meets the standard.

After adapting the wireless network parameter according to the first network optimization strategy, the cloud game wireless network optimization apparatus disconnects the wireless network and quickly reconnects it, so that the cloud game wireless network optimization apparatus can negotiate with the new wireless network parameter, thereby reducing the network interference in the cloud network environment and improving the operation experience of the cloud game.

In this embodiment, the cloud game wireless network optimization apparatus determines that the network evaluation result corresponding to the current wireless network environment is a strong interference network and/or a stuck network according to the network environment detection score and adopts the first network optimization strategy to adapt the wireless network parameter, so as to optimize the wireless network environment. This can effectively reduce the network interference of the wireless network environment and improve the fluency of the cloud game.

Please refer to FIG. 5. FIG. 5 is a flow chart of a network optimization strategy for a weak interference network and/or a good network environment in the cloud game wireless network optimization method according to an embodiment of the present disclosure.

In the following disclosure, the optimization based on the network optimization strategy corresponding to a network evaluation result representing a strong interference network and/or a stuck network will be illustrated. The method comprises the following Steps 501-502:

Step 501: if the network evaluation result corresponding to the wireless network environment is a weak interference network and/or the wireless network environment is good, determining the network optimization strategy corresponding to the wireless network environment to be a second network optimization strategy.

Step 502: optimizing the cloud game wireless network environment according to the second network optimization strategy, wherein the second network optimization strategy is to increase a wireless aggregation rate, increase a wireless transmission rate, and increase a cloud game screen bit rate.

In this embodiment, the cloud game wireless network optimization apparatus obtains a network environment score corresponding to the wireless network environment, determines that the network environment score is greater than the preset strong interference level threshold and is less than the preset weak interference level threshold, determines that the network environment score falls into the weak interference level range, determines that the network evaluation result corresponding to the wireless network environment is a weak interference network, and/or detects the operation status of the cloud game and determines that the network evaluation result is good. Thus, the cloud game wireless network optimization apparatus determines that the network optimization strategy corresponding to the current wireless environment is the second network optimization strategy, where the second network optimization strategy is the network optimization strategy optimized for a weak interference network and/or a good network.

Specifically, after determining that the network optimization strategy corresponding to the current wireless network environment is the second network optimization strategy, the cloud game wireless network optimization apparatus optimizes the wireless network environment according to the second network optimization strategy.

Specifically, the cloud game wireless network optimization apparatus adapts the wireless network parameter according to the second network optimization strategy and increases the wireless aggregation rate, the wireless transmission rate, the cloud game screen bit rate, and the image quality effect of the cloud game for the weak interference network and/or a good network is enhanced.

In this embodiment the cloud game wireless network optimization apparatus determines that the network evaluation result corresponding to the current wireless network environment is a weak interference network according to the network environment detection score and adopts a second network optimization strategy to adapt the wireless network parameter. On the premise of ensuring the stability of the cloud game operation, the picture bit rate of the cloud game can be improved, and the picture quality effect of the cloud game can be improved.

Please refer to FIG. 6. FIG. 6 is a flow chart of the flow of an embodiment of a cloud game wireless network optimization method performing an optimization for a second time according to the operation status of the cloud game.

In the following disclosure, the method for performing an optimization for a second time during the operation process will be illustrated. The method comprises Steps 601˜603:

Step 601: obtaining an updated cloud game operation parameter, and determining a optimization status of the cloud game based on the updated cloud game operation parameter.

Step 602: evaluating the wireless network environment according to the optimization state, and obtaining a network optimization evaluation result.

Step 603: optimizing the wireless network environment for a second time according to the network optimization evaluation result.

In this embodiment, after optimizing the cloud game network environment according to the network evaluation result, the cloud game wireless network optimization apparatus obtains the updated cloud game operation parameter during the cloud game operation and determines the cloud game optimization state according to the updated cloud game operation parameter. Here, the updated cloud game operation parameter includes one or more of the cloud game network latency, the cloud game lag ratio, the cloud game average rate, the cloud game screen bit rate.

Specifically, after the cloud game wireless network optimization apparatus obtains the cloud game network latency, the cloud game lag proportion, and the cloud game screen bit rate, the cloud game wireless network optimization apparatus obtains the reduction range of cloud game network latency and/or the cloud game lag proportion. If the reduction of the cloud game network latency and/or cloud game lag proportion is less than the preset lag optimization threshold, the cloud game wireless network optimization apparatus determines that the evaluation result of the current wireless network environment is a stuck network and need to perform the optimization on the cloud game for the second time.

Specifically, the cloud game wireless network optimization apparatus determines an increase in the average cloud game rate and the cloud game screen bit rate. If the increase in the average cloud game rate and/or the cloud game screen bit rate is less than the preset speed optimization threshold, the cloud game wireless network optimization apparatus determines that the evaluation result of the current wireless network environment is not good enough and need to perform the optimization on the cloud game for the second time.

Optionally, the preset stuttering optimization thresholds and acceleration optimization thresholds can be obtained by the tester based on multiple network optimization experiments.

Specifically, after determining that the optimized wireless network environment does not reach the preset optimization result, the cloud game wireless network optimization apparatus performs a second optimization on the network environment based on the updated network evaluation result.

If the updated network evaluation result represents a stuck network, the first network optimization strategy is used to optimize the wireless network environment for the second time.

If the updated network evaluation result is good, the second network optimization strategy is used to optimize the cloud gaming wireless network environment for the second time.

In this embodiment, the cloud game wireless network optimization apparatus obtains the updated cloud game operation parameter, determines the cloud game optimization state according to the cloud game operation parameter, evaluates the wireless network environment according to the cloud game optimization state, obtains the network optimization evaluation result, and performs optimization of the wireless network environment for the second time according to the network optimization evaluation result, so as to implement the dynamic optimization on the wireless network environment.

In order to better implement the above-mentioned cloud game wireless network optimization method, a cloud game wireless network optimization device is disclosed according to an embodiment of the present disclosure. Please refer to FIG. 7. FIG. 7 is a diagram of a cloud game wireless network optimization device according to an embodiment of the present disclosure. The cloud game wireless network optimization device 700 comprises a network detection module 701, a network identification module 702 and a network optimization module 703.

The network detection module 701 is configured to obtain network detection data of a wireless network environment of the cloud game and/or a cloud game operation parameter of the cloud game.

The network identification module 702 is configured to determine a network assessment result of the wireless network environment according to the network detection data and/or the cloud game operation parameter.

The network optimization module 703 is configured to determine a corresponding network optimization strategy according to the network evaluation result and dynamically optimize the wireless network environment according to the network optimization strategy.

In some embodiments of the present disclosure, the operation of the cloud game wireless network optimization device 700 for determining the network assessment result of the wireless network environment according to the network detection data and/or the cloud game operation parameters comprises:
calculating a network detection score corresponding to each of the network detection data;
calculating a network environment score of the wireless network environment according to the network detection score; and/or
determining the cloud game operation state according to the cloud game operation parameter;
determining the corresponding network assessment result based on the network environment score and/or the cloud game operation status.

In some embodiments of the present disclosure, the cloud game wireless network optimization device 700 is configured to perform the following operations.

The operation of the cloud game wireless network optimization device 700 for calculating network detection score corresponding to each of the network detection data comprises:
querying a preset network parameter weight database to obtain a network score weight corresponding to the network detection data; and
according to the network scoring weight, performing a weighted calculation on the network detection data to obtain the network detection score.

In some embodiments of the present disclosure, the cloud game wireless network optimization device 700 is also configured to perform the following operations.

The operation of the cloud game wireless network optimization device 700 for determining the corresponding network optimization strategy according to the network evaluation result and optimizing the wireless network environment according to the network optimization strategy comprises:
upon a condition that the network assessment result corresponding to the wireless network environment is a strong interference network and/or the wireless network environment is stuck, determining the network optimization strategy corresponding to the wireless network environment to be a first network optimization strategy;
optimizing the wireless network environment according to the first network optimization strategy, where the first network optimization strategy is to reduce a wireless aggregation rate, reduce a wireless transmission rate, and switch a wireless negotiated bandwidth.

In some embodiments of the present disclosure, the cloud game wireless network optimization device 700 is also configured to perform the following operations.

The operation of the cloud game wireless network optimization device 700 for determining the corresponding network optimization strategy according to the network evaluation result and optimizing the wireless network environment according to the network optimization strategy comprises:
upon a condition that the network evaluation result corresponding to the wireless network environment is a weak interference network and/or the wireless network environment is good, determining the network optimization strategy corresponding to the wireless network environment to be a second network optimization strategy; and
optimizing the cloud game wireless network environment according to the second network optimization strategy, wherein the second network optimization strategy is to increase a wireless aggregation rate, increase a wireless transmission rate, and increase a cloud game screen bit rate.

In some embodiments of the present disclosure, the cloud game wireless network optimization device 700 is also configured to perform the following operations.

The operation of the cloud game wireless network optimization device 700 for determining the corresponding network optimization strategy according to the network evaluation result and optimizing the wireless network environment according to the network optimization strategy comprises:
obtaining an updated cloud game operation parameter, and determining an optimization status of the cloud game based on the updated cloud game operation parameter;
evaluating the wireless network environment according to the optimization state, and obtaining a network optimization evaluation result; and
optimizing the wireless network environment for a second time according to the network optimization evaluation result.

The technical scheme according to an embodiment of the present disclosure includes: obtaining network detection data of a wireless network environment of the cloud game and/or a cloud game operation parameter of the cloud game; determining a network assessment result of the wireless network environment according to the network detection data and/or the cloud game operation parameter; and determining a corresponding network optimization strategy according to the network evaluation result, and optimizing the wireless network environment according to the network optimization strategy. The technical scheme according to an embodiment of the present disclosure determines the network evaluation result by evaluating the network detection data in the wireless network environment of the cloud game and the cloud game operation parameter of the cloud game, determines the network situation of the wireless network environment according to the network evaluation result, and selects the corresponding network optimization strategy to optimize the wireless network environment based on the network evaluation result. In this way, the wireless anti-interference ability could be increased, the congestion is reduced, the network quality could be ensured, and the running experience of the cloud game can be effectively improved under the premise of ensuring the bandwidth of the cloud game.

In addition, a cloud game wireless network optimization apparatus is disclosed according to an embodiment of the present disclosure. Please refer to FIG. 8. FIG. 8 is a diagram a cloud game wireless network optimization apparatus according to an embodiment of the present disclosure.

The cloud game wireless network optimization apparatus integrates any of the above-mentioned embodiments. Here, the cloud game wireless network optimization apparatus comprises:
one or more processors;
a memory; and
one or more applications, stored in the memory and configured to be executed by the processor to perform one or more steps of the cloud game wireless network optimization of any of the above-mentioned embodiments.

The cloud game wireless network optimization apparatus may include a processor 801 having one or more processing cores, a memory 802 having one or more computer-readable storage media, a power supply 803, and an input unit 804. The structure of the cloud game wireless network optimization apparatus shown in FIG. 8 does not constitute a limitation of present disclosure. IN the actual implementation, the cloud game wireless network optimization apparatus may include more or fewer parts, or can combine certain parts, or have different arrangements of the components.

The processor 801 is the control center of the cloud game wireless network optimization device, which utilizes various interfaces and lines to connect all parts of the entire cloud gaming wireless network optimization device, and performs various functions and processes data of the cloud gaming wireless network optimization device by running or executing software programs and/or modules stored in the memory 802, and calling the data stored in the memory 802, so as to carry out overall monitoring of the cloud game wireless network optimization device. Optionally, the processor 801 may include one or more processing cores, and preferably, the processor 801 may integrate an application processor and a modem processor. The application processor mainly handles the operating system, user interface, and application applications, etc., The modem processor mainly handles wireless communications. Understandably, the modem processor can be independent from the processor 801.

The memory 802 can be used to store software programs and modules. The processor 801 can perform various functional applications and data processing by running software programs and modules stored in memory 802. The memory 802 may include a storage program area and a storage data area, where the storage program area can store the operating system, at least one function required application (such as sound playback function, image playback function). The storage data area can store the data created by the cloud game wireless network optimization device. In addition, the memory 802 may include high-speed random access memory and may include non-volatile memory such as a disk storage device, a flash memory, or other volatile solid-state storage device. Correspondingly, the memory 802 may also include a memory controller to provide access from the processor 801 to the memory 802.

The cloud game wireless network optimization device also comprises a power supply 803 that supplies power to each component. Preferably, the power supply 803 can be logically connected with the processor 801 through the power management system, so as to realize the functions of managing charging, discharging, and power consumption management through the power management system. The power supply 803 can also include any component such as one or more DC or AC power sources, recharging systems, power fault detection circuits, power converters or inverters, and power status indicators.

The cloud game wireless network optimization device may also include an input unit 804 that can be used to receive input numeric or character information and generate keyboard, mouse, joystick, optical or trackball signal input related to user settings and function control.

Although not shown, the cloud game wireless network optimization devices can also include display units, which will not be repeated here. Specifically, in this embodiment, the processor 801 in the cloud game wireless network optimization device will load the executable file corresponding to the process of one or more applications into the memory 802 according to the following instructions, and the processor 801 will run the application stored in the memory 802, thereby realizing various functions as follows:
obtaining network detection data of a wireless network environment of the cloud game and/or a cloud game operation parameter of the cloud game;
determining a network assessment result of the wireless network environment according to the network detection data and/or the cloud game operation parameter; and
determining a corresponding network optimization strategy according to the network evaluation result, and optimizing the wireless network environment according to the network optimization strategy.

In the above embodiments, the descriptions of each embodiment have their own emphasis, and the part that is not described in detail in a certain embodiment can be referred to the detailed description of the other embodiments above, and will not be repeated here.

In the specific embodiment, each of the above units or structures can be realized as an independent entity, or can be arbitrarily combined, and is realized as the same or several entities, and the specific embodiment of each of the above units or structures can be referred to in the previous method embodiment, and will not be repeated herein.

The specific implementation of each of the above operations can be found in the previous embodiment, which will not be repeated here.

Above are embodiments of the present disclosure, which does not limit the scope of the present disclosure. Any modifications, equivalent replacements or improvements within the spirit and principles of the embodiment described above should be covered by the protected scope of the disclosure.

1. A method for optimizing a wireless network for a cloud game, the method comprising:
obtaining network detection data of a wireless network environment of the cloud game and a cloud game operation parameter of the cloud game;
determining a network assessment result of the wireless network environment according to the network detection data or the cloud game operation parameter; and
determining a corresponding network optimization strategy according to the network evaluation result, and optimizing the wireless network environment according to the network optimization strategy.

2. The method of claim 1, wherein the step for determining the network assessment result of the wireless network environment according to the network detection data and the cloud game operation parameters comprises:
calculating a network detection score corresponding to each of the network detection data;
calculating a network environment score of the wireless network environment according to the network detection score, and determining the cloud game operation state according to the cloud game operation parameter;
determining the corresponding network assessment result based on the network environment score and the cloud game operation status.

3. The method of claim 2, wherein the step for calculating network detection score corresponding to each of the network detection data comprises:
querying a preset network parameter weight database to obtain a network score weight corresponding to the network detection data; and
according to the network scoring weight, performing a weighted calculation on the network detection data to obtain the network detection score.

4. The method of claim 2, wherein the step of determining the corresponding network assessment result based on the network environment score and the cloud game operation status comprises:
obtaining a weak interference level threshold and a strong interference level threshold;
determining an interference level range of the network environment score based on the strong interference level threshold and the weak interference level threshold; and
generating a network assessment result corresponding to the interference level range.

5. The method of claim 2, wherein the step of determining the corresponding network optimization strategy according to the network evaluation result and optimizing the wireless network environment according to the network optimization strategy comprises:
upon a condition that the network assessment result corresponding to the wireless network environment is a strong interference network and the wireless network environment is stuck, determining the network optimization strategy corresponding to the wireless network environment to be a first network optimization strategy; and
optimizing the wireless network environment according to the first network optimization strategy, wherein the first network optimization strategy is to reduce a wireless aggregation rate, reduce a wireless transmission rate, and switch a wireless negotiated bandwidth.

6. The method of claim 2, wherein the step of determining the corresponding network optimization strategy according to the network evaluation result and optimizing the wireless network environment according to the network optimization strategy comprises:
upon a condition that the network evaluation result corresponding to the wireless network environment is a weak interference network and the wireless network environment is good, determining the network optimization strategy corresponding to the wireless network environment to be a second network optimization strategy; and
optimizing the cloud game wireless network environment according to the second network optimization strategy, wherein the second network optimization strategy is to increase a wireless aggregation rate, increase a wireless transmission rate, and increase a cloud game screen bit rate.

7. The method of claim 5, wherein the step of determining the corresponding network optimization strategy according to the network evaluation result and optimizing the wireless network environment according to the network optimization strategy comprises:
obtaining an updated cloud game operation parameter, and determining an optimization status of the cloud game based on the updated cloud game operation parameter;
evaluating the wireless network environment according to the optimization state, and obtaining a network optimization evaluation result; and
optimizing the wireless network environment for a second time according to the network optimization evaluation result.

8. The method of claim 6, wherein the step of determining the corresponding network optimization strategy according to the network evaluation result and optimizing the wireless network environment according to the network optimization strategy comprises:
obtaining an updated cloud game operation parameter, and determining an optimization status of the cloud game based on the updated cloud game operation parameter;
evaluating the wireless network environment according to the optimization state, and obtaining a network optimization evaluation result; and
optimizing the wireless network environment for a second time according to the network optimization evaluation result.

9. The method of claim 1, wherein the cloud game operation parameter comprises at least one of a cloud game network latency;
a proportion of cloud game lag;
a cloud game screen bit rate;
an average cloud game rate.

10-18. (canceled)

19. A cloud game wireless network optimization apparatus, comprising:
one or more processors;
a memory; and
one or more applications, stored in the memory and configured to be executed by the processor to perform operations comprising:
obtaining network detection data of a wireless network environment of the cloud game or a cloud game operation parameter of the cloud game;
determining a network assessment result of the wireless network environment according to the network detection data or the cloud game operation parameter; and
determining a corresponding network optimization strategy according to the network evaluation result, and optimizing the wireless network environment according to the network optimization strategy.

20. A non-transitory computer readable medium, storing a computer program, wherein the computer program is executed by a processor to perform operations comprising:
obtaining network detection data of a wireless network environment of the cloud game or a cloud game operation parameter of the cloud game;
determining a network assessment result of the wireless network environment according to the network detection data or the cloud game operation parameter; and
determining a corresponding network optimization strategy according to the network evaluation result, and optimizing the wireless network environment according to the network optimization strategy.

21. The cloud game wireless network optimization apparatus of claim 19, wherein the operation for determining the network assessment result of the wireless network environment according to the network detection data or the cloud game operation parameters comprises:
calculating a network detection score corresponding to each of the network detection data;
calculating a network environment score of the wireless network environment according to the network detection score, and determining the cloud game operation state according to the cloud game operation parameter;
determining the corresponding network assessment result based on the network environment score/or the cloud game operation status.

22. The cloud game wireless network optimization apparatus of claim 21, wherein the operation for calculating network detection score corresponding to each of the network detection data comprises:
querying a preset network parameter weight database to obtain a network score weight corresponding to the network detection data; and
according to the network scoring weight, performing a weighted calculation on the network detection data to obtain the network detection score.

23. The cloud game wireless network optimization apparatus of claim 21, wherein the operation of determining the corresponding network optimization strategy according to the network evaluation result and optimizing the wireless network environment according to the network optimization strategy comprises:
upon a condition that the network assessment result corresponding to the wireless network environment is a strong interference network and the wireless network environment is stuck, determining the network optimization strategy corresponding to the wireless network environment to be a first network optimization strategy; and
optimizing the wireless network environment according to the first network optimization strategy, wherein the first network optimization strategy is to reduce a wireless aggregation rate, reduce a wireless transmission rate, and switch a wireless negotiated bandwidth.

24. The cloud game wireless network optimization apparatus of claim 21, wherein the operation of determining the corresponding network optimization strategy according to the network evaluation result and optimizing the wireless network environment according to the network optimization strategy comprises:
upon a condition that the network evaluation result corresponding to the wireless network environment is a weak interference network and the wireless network environment is good, determining the network optimization strategy corresponding to the wireless network environment to be a second network optimization strategy; and
optimizing the cloud game wireless network environment according to the second network optimization strategy, wherein the second network optimization strategy is to increase a wireless aggregation rate, increase a wireless transmission rate, and increase a cloud game screen bit rate.

25. The cloud game wireless network optimization apparatus of claim 23, wherein the operation of determining the corresponding network optimization strategy according to the network evaluation result and optimizing the wireless network environment according to the network optimization strategy comprises:
obtaining an updated cloud game operation parameter, and determining an optimization status of the cloud game based on the updated cloud game operation parameter;
evaluating the wireless network environment according to the optimization state, and obtaining a network optimization evaluation result; and
optimizing the wireless network environment for a second time according to the network optimization evaluation result.

26. The cloud game wireless network optimization apparatus of claim 19, wherein the cloud game operation parameter comprises at least one of:
a cloud game network latency;
a proportion of cloud game lag;
a cloud game screen bit rate; and
an average cloud game rate.

27. The non-transitory computer readable medium of claim 20, wherein the operation for determining the network assessment result of the wireless network environment according to the network detection data or the cloud game operation parameters comprises:
calculating a network detection score corresponding to each of the network detection data;
calculating a network environment score of the wireless network environment according to the network detection score, and determining the cloud game operation state according to the cloud game operation parameter;
determining the corresponding network assessment result based on the network environment score and the cloud game operation status.

28. The non-transitory computer readable medium of claim 27, wherein the operation for calculating network detection score corresponding to each of the network detection data comprises:
querying a preset network parameter weight database to obtain a network score weight corresponding to the network detection data; and
according to the network scoring weight, performing a weighted calculation on the network detection data to obtain the network detection score.

29. The non-transitory computer readable medium of claim 27, wherein the operation of determining the corresponding network optimization strategy according to the network evaluation result and optimizing the wireless network environment according to the network optimization strategy comprises:
upon a condition that the network assessment result corresponding to the wireless network environment is a strong interference network and the wireless network environment is stuck, determining the network optimization strategy corresponding to the wireless network environment to be a first network optimization strategy; and
optimizing the wireless network environment according to the first network optimization strategy, wherein the first network optimization strategy is to reduce a wireless aggregation rate, reduce a wireless transmission rate, and switch a wireless negotiated bandwidth.
